(19) United States
(12) Patent Application Publication
(10) Pub. No.: US 2021/0099945 A1
(43) Pub. Date: Apr. 1, 2021

(54) REDUCED OVERHEAD NETWORK SLICE SELECTION ASSISTANCE INFORMATION (NSSAI) SIGNALING

(71) Applicant: QUALCOMM Incorporated, San Diego, CA (US)

(72) Inventors: Mahmoud WATFA, St. Leonard (CA); Haris ZISIMOPOULOS, London (GB); Lenaig Genevieve CHAPONNIERE, La Jolla, CA (US); Miguel GRIOT, La Jolla, CA (US); Sebastian SPEICHER, Wallisellen (CH)

(21) Appl. No.: 17/033,603

(22) Filed: Sep. 25, 2020

(30) Foreign Application Priority Data
Sep. 27, 2019 (GR) 20190100420

(51) Int. Cl. H04W 48/08; H04W 48/18

(52) U.S. Cl. CPC H04W 48/08; H04W 48/18

(57) ABSTRACT

Certain aspects of the present disclosure provide techniques for network slice selection assistance information (NSSAI) signaling. A method that may be performed by a user equipment (UE) includes receiving a first message comprising one or more fields, each field indicating a network slice identifier via a plurality of bits. The method generally includes sending and/or receiving at least a second message referencing at least one field of the first message to indicate the network slice identifier via a reduced number of bits.

### CROSS-REFERENCE TO RELATED APPLICATIONS

This application claims benefit to Greece Patent Application Serial No. 20190100420, entitled “Reduced Overhead NSSAI Signaling”, filed Sep. 27, 2019, and assigned to the assignee hereof, the contents of which are hereby incorporated by reference in its entirety.

### BACKGROUND

### Field of the Disclosure

Aspects of the present disclosure relate to wireless communications, and more particularly, to techniques for network slice selection assistance information (NSSAI) signaling.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved network slice selection assistance information (NSSAI) signaling.

One innovative aspect of the subject matter described in this disclosure can be implemented in a method for wireless communication by a user equipment (UE). The method generally includes receiving a first message comprising one or more fields, each field indicating a network slice identifier via a plurality of bits. The method generally includes sending and/or receiving at least a second message referencing at least one field of the first message to indicate the network slice identifier via a reduced number of bits.

One innovative aspect of the subject matter described in this disclosure can be implemented in a method for wireless communication by a network entity. The method generally includes sending a first message comprising one or more fields, each field indicating a network slice identifier via a plurality of bits. The method generally includes sending and/or receiving at least a second message referencing at least one field of the first message to indicate the network slice identifier via a reduced number of bits.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example a base station (BS) and user equipment (UE), in accordance with certain aspects of the present disclosure.

FIG. 3 is a block diagram illustrating an example architecture of a core network (CN) and radio access network (RAN), in accordance with certain aspects of the present disclosure.

FIG. 4 is an example format of a network slice selection assistance information (NSSAI) information element (IE).

FIG. 5 is an example format of a single NSSAI (S-NSSAI) IE.

FIG. 6 is a table showing example NSSAI inclusion modes.

FIG. 7 is a call flow illustrating example NSSAI signaling.

FIG. 8 is an example format of a 5GS update type IE with a NSSAI efficient signaling (NES) mode indication, in accordance with certain aspects of the present disclosure.

FIG. 9 is an example format of a 5GMM capability IE with a NES mode indication, in accordance with certain aspects of the present disclosure.

FIG. 10 is an example format of a network slicing IE with a NES mode indication, in accordance with certain aspects of the present disclosure.

FIG. 11 is an example format of a 5GS network feature support IE with a NES mode indication, in accordance with certain aspects of the present disclosure.

FIG. 12 is an example format of a NSSAI inclusion mode IE with a NES mode indication, in accordance with certain aspects of the present disclosure.

FIG. 13 is an example format of a NSSAI IE with reduced overhead for NES, in accordance with certain aspects of the present disclosure.

FIG. 14 is a call flow diagram illustrating example signaling for NES negotiation and NES operation during and after initial registration, in accordance with aspects of the present disclosure.

FIG. 15 is an example format of a NSSAI IE with reduced overhead for NES, in accordance with certain aspects of the present disclosure.

FIG. 16 is an example format of a NSSAI IE with reduced overhead for NES, in accordance with certain aspects of the present disclosure.

FIGS. 17A-17C illustrate an example format of an uplink non-access stratum (NAS) transport message with NES operation, in accordance with certain aspects of the present disclosure.

FIG. 18 illustrates an example format of a PDU session establishment accept message with NES operation, in accordance with certain aspects of the present disclosure.

FIG. 19 is a call flow diagram illustrating example signaling for NES operation during protocol data unit (PDU) session establishment, in accordance with aspects of the present disclosure.

FIG. 20 is a flow diagram illustrating example operations for wireless communication by a UE, in accordance with certain aspects of the present disclosure.

FIG. 21 is a flow diagram illustrating example operations for wireless communication by a network entity, in accordance with certain aspects of the present disclosure.

FIG. 22 illustrates a communications device that may include various components configured to perform operations for the techniques disclosed herein in accordance with aspects of the present disclosure.

FIG. 23 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for network slice selection assistance information (NSSAI) signalling. Aspects may provide NSSAI efficient signaling (NES) with reduced overhead. In some examples, a bitmap is used to indicate single NSSAI (S-NSSAI) values, such as S-NSSAI indicated in a previous message (e.g., a previous Allowed NSSAI information element (IE)).

The following description provides examples of NSSAI signaling in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies me. For clarity, while aspects may be described herein using terminology commonly associated with 3G, 4G, and/or new radio (e.g., 5G NR) wireless technologies, aspects of the present disclosure can be applied in other generation-based communication systems, including later technologies.

NR access may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

Certain wireless networks utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. The system bandwidth may also be partitioned into subbands.

5G NR may utilize OFDM with a cyclic prefix (CP) on the uplink and downlink and include support for half-duplex operation using time division duplexing (TDD). A subframe can be 1 ms, but the basic transmission time interval (TTI) may be referred to as a slot. A subframe contains a variable number of slots (e.g., 1, 2, 4, 8, 16, . . . slots) depending on the subcarrier spacing (SCS). The NR resource block (RB) may be 12 consecutive frequency subcarriers. NR may support a base SCS of 15 KHz and other subcarrier spacing may be defined with respect to the base SCS, for example, 30 kHz, 60 kHz, 120 kHz, 240 kHz, etc. The symbol and slot lengths scale with the SCS. The CP length also depends on the SCS. 5G NR may also support beamforming and beam direction may be dynamically configured. Multiple-input multiple-output (MIMO) transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

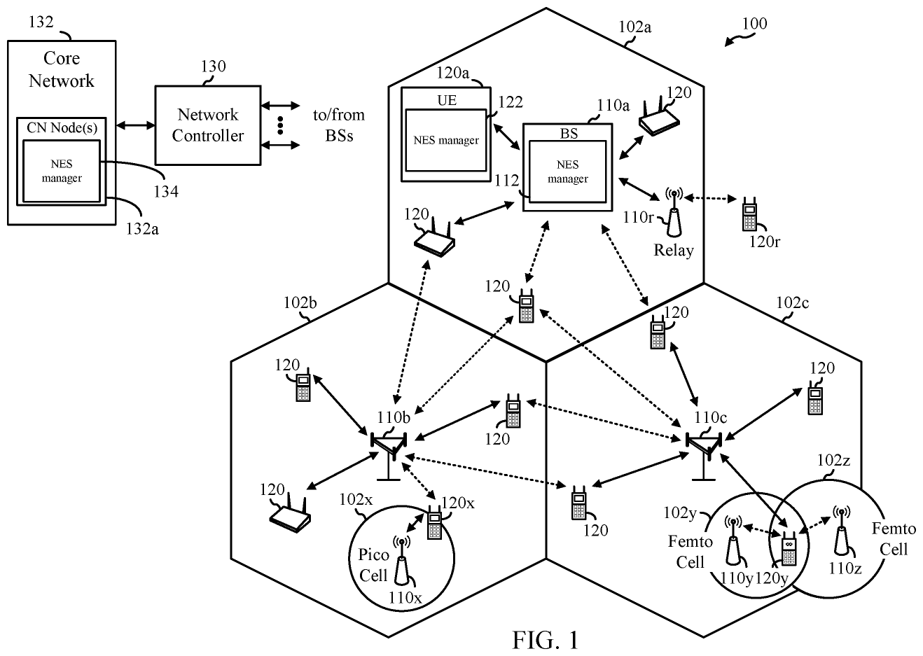

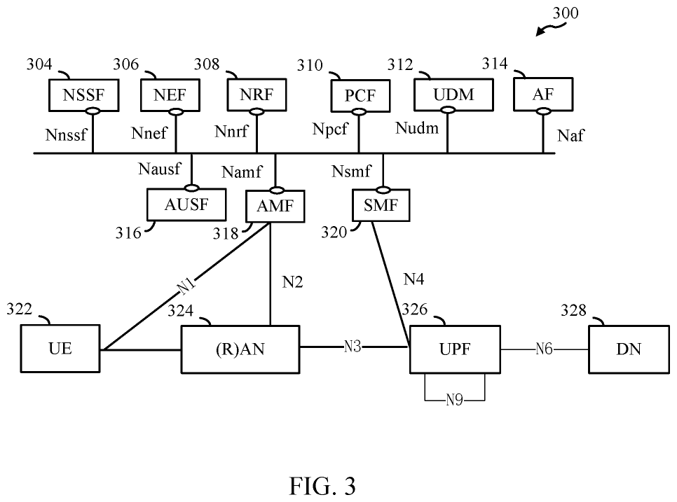

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more BSs 110 and/or UEs 120 via one or more interfaces as discussed more detail below with respect to FIG. 3.

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

The wireless communication network 100 may be in communication with the CN 132, which includes one or more CN nodes 132a. A network controller 130 may couple to a set of BSs 110 and provide coordination and control for these BSs 110. The network controller 130 may communicate with the BSs 110 via a backhaul. The network controller 130 may also couple to one or more of the CN nodes 132a.

According to certain aspects, the BSs 110 and UEs 120 may be configured for NSSAI signaling with reduced overhead. As shown in FIG. 1, the BS 110a includes a NES manager 112. The NES manager 112 may be configured for reduced overhead NSSAI signaling, in accordance with aspects of the present disclosure. As shown in FIG. 1, the UE 120a includes a NES manager 122. The NES manager 122 may be configured for reduced overhead NSSAI signaling, in accordance with aspects of the present disclosure. As shown in FIG. 1, the CN nodes 132a may include NES manager 134. The NES manager 134 may be configured for reduced overhead NSSAI signaling.

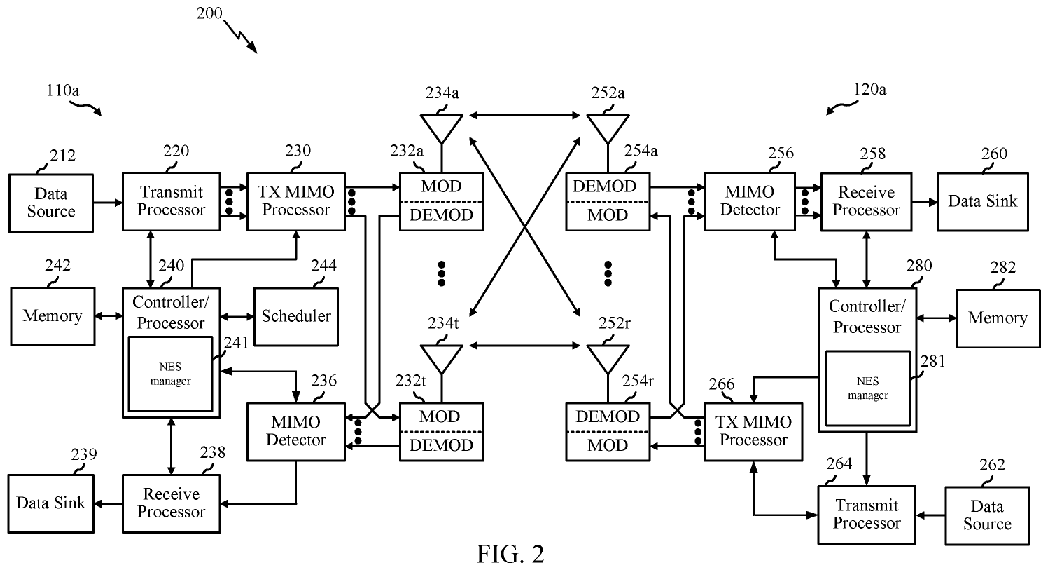

FIG. 2 illustrates example components of BS 110a and UE 120a (e.g., in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. For example, a base station may transmit a MAC CE to a UE to put the UE into a discontinuous reception (DRX) mode to reduce the UE's power consumption. The MAC-CE may be carried in a shared channel such as a physical downlink shared channel (PDSCH), a physical uplink shared channel (PUSCH), or a physical sidelink shared channel. A MAC-CE may also be used to communicate information that facilitates communication, such as information regarding buffer status and available power headroom.

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the demodulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

The controller/processor 280 and/or other processors and modules at the UE 120a may perform or direct the execution of processes for the techniques described herein. For example, as shown in FIG. 2, the controller/processor 240 of the BS 110a has an NES manager 241 that may be configured for reduced overhead NSSAI signaling, according to aspects described herein. As shown in FIG. 2, the controller/processor 280 of the UE 120a has an NES manager 241 that may be configured for reduced overhead NSSAI signaling, according to aspects described herein. Although shown at the controller/processor, other components of the UE 120a and BS 110a may be used to perform the operations described herein.

FIG. 3 is a block diagram illustrating an example architecture of a core network (CN) 300 (e.g., such as the CN 132 in FIG. 1) in communication with a RAN 324, in accordance with certain aspects of the present disclosure. As shown in FIG. 3, the example architecture includes the CN 300, RAN 324, UE 322, and data network (DN) 328 (e.g. operator services, Internet access or third party services).

The CN 300 may host core network functions. CN 300 may be centrally deployed. CN 300 functionality may be offloaded (e.g., to advanced wireless services (AWS)), in an effort to handle peak capacity. As shown in FIG. 3, the example CN 300 may be implemented by one or more network entities that perform network functions (NF) including Network Slice Selection Function (NSSF) 304, Network Exposure Function (NEF) 306, NF Repository Function (NRF) 308, Policy Control Function (PCF) 310, Unified Data Management (UDM) 312, Application Function (AF) 314, Authentication Server Function (AUSF) 316, Access and Mobility Management Function (AMF) 318, Session Management Function (SMF) 320; User Plane Function (UPF) 326, and various other functions (not shown) such as Unstructured Data Storage Function (UDSF); Unified Data Repository (UDR); 5G-Equipment Identity Register (5G-EIR); and/or Security Edge Protection Proxy (SEPP).

The AMF 318 may include the following functionality (some or all of the AMF functionalities may be supported in one or more instances of an AMF): termination of RAN control plane (CP) interface (N2); termination of non-access stratum (NAS) (e.g., N1), NAS ciphering and integrity protection; registration management; connection management; reachability management; mobility management; lawful intercept (for AMF events and interface to L1 system); transport for session management (SM) messages between UE 322 and SMF 320; transparent proxy for routing SM messages; access authentication; access authorization; transport for short message service (SMS) messages between UE 322 and a SMS function (SMSF); Security Anchor Functionality (SEAF); Security Context Management (SCM), which receives a key from the SEAF that it uses to derive access-network specific keys; Location Services management for regulatory services; transport for Location Services messages between UE 322 and a location management function (LMF) as well as between RAN 324 and LMF; evolved packet service (EPS) bearer ID allocation for interworking with EPS; and/or UE mobility event notification; and/or other functionality.

SMF 320 may support: session management (e.g., session establishment, modification, and release), UE IP address allocation and management, dynamic host configuration protocol (DHCP) functions, termination of NAS signaling related to session management, downlink data notification, and traffic steering configuration for UPF for proper traffic routing. UPF 326 may support: packet routing and forwarding, packet inspection, quality-of-service (QoS) handling, external protocol data unit (PDU) session point of interconnect to DN 328, and anchor point for intra-RAT and inter-RAT mobility. PCF 310 may support: unified policy framework, providing policy rules to control protocol functions, and/or access subscription information for policy decisions in UDR. AUSF 316 may acts as an authentication server. UDM 312 may support: generation of Authentication and Key Agreement (AKA) credentials, user identification handling, access authorization, and subscription management. NRF 308 may support: service discovery function, and maintain NF profile and available NF instances. NSSF may support: selecting of the Network Slice instances to serve the UE 322, determining the allowed network slice selection assistance information (NSSAI), and/or determining the AMF set to be used to serve the UE 322.

NEF 306 may support: exposure of capabilities and events, secure provision of information from external application to 3 GPP network, translation of internal/external information. AF 314 may support: application influence on traffic routing, accessing NEF 306, and/or interaction with policy framework for policy control.

As shown in FIG. 3, the CN 300 may be in communication with the AS 302, UE 322, RAN 324, and DN 328. In some examples, the CN 300 communicates with the external AS 302 via the NEF 306 and/or AF 314. In some examples, the CN 300 communicates with the RAN 324 (e.g., such as the BS 110a in the wireless communication network 100 illustrated in FIG. 1) and/or the UE 322 (e.g., such as the UE 120a in the wireless communication network 100 illustrated in FIG. 1) via the AMF 318.

The NSSF 304 supports the following functionality: selecting of the network slice instances to serve the UE 322; determining the allowed network slice selection assistance information (NSSAI); and/or determining the AMF set to be used to serve the UE 322.

As mentioned above, aspects of the present disclosure relate to network slice selection assistance information (NSSAI) signaling. A network slice may be defined as a logical network that provides specific network capabilities and network characteristics. A network slice instance may be defined as a set of network function instances and the required resources (e.g., compute, storage, and networking resources) which form a deployed network slice.

A network slice is identified by single network slice selection assistance information (S-NSSAI). NSSAI is a list of one or more S-NSSAIs. An S-NSSAI includes a slice/service type (SST), which refers to the expected network slice behavior (e.g., features and services), and a slice differentiator (SD), which is optional information that complements the SST(s) to differentiate amongst multiple network slices of the same SST. An S-NSSAI can have standard values (e.g., including an SST with a standardized SST value and no SD) or non-standard values (e.g., including an SST and an SD or including an SST without a standardized SST value and no SD). An S-NSSAI with a non-standard value identifies a single network slice within the PLMN with which it is associated. An S-NSSAI with a non-standard value may not be used by the UE in access stratum procedures in any PLMN other than the one to which the S-NSSAI is associated.

Network slices may differ with respects to supported features and network functions optimizations. For example, different S-NSSAIs may have different SSTs. An operator can deploy multiple network slice instances delivering the same features, but for different groups of UEs (e.g., dedicated to a customer different S-NSSAIs with the same SST but different SDs). The network may serve a single UE with one or more network slice instances simultaneously (e.g., via the 5G-AN). In some examples, a UE may be associated with up to eight different S-NSSAIs in total.

AMF instances can be common to network slice instances serving a UE. Selection of the set of network slice instances for a UE is triggered by the first contacted AMF in a registration procedure normally by interacting with the NSSF. A PDU session may belong to one specific network slice instance per PLMN. Different network slice instances may not share a protocol data unit (PDU) session, though different slices may have slice-specific PDU sessions using the same data network name (DNN). In order to enable PDU transmission in a network slice, the UE may request establishment of a PDU session in a network slice towards a DN associated with an S-NSSAI and a (DNN if there is no established PDU session adequate for the PDU transmission. The S-NSSAI included is part of allowed NSSAI of the serving PLMN, which is an S-NSSAI value valid in the serving PLMN, and in roaming scenarios the mapped S-NSSAI is also included for the PDU session if available.

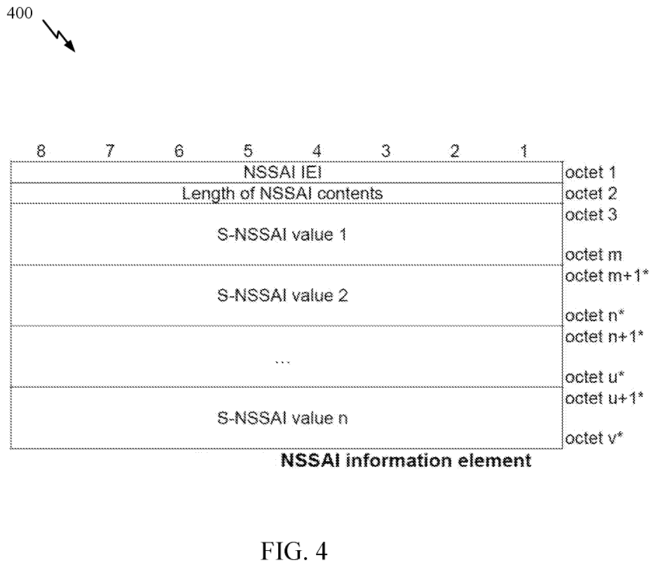

In certain systems, S-NSSAI values are provided in an NSSAI information element (IE). The NSSAI IE identifies a collection of S-NSSAIs. FIG. 4 is an example format of the NSSAI IE 400. As shown in FIG. 4, the example NSSAI IE 400 may have a length between 4 and 146 octets. The NSSAI IE 400 may indicate up to eight S-NSSAI values for requested NSSAIs (where NSSAI IE 400 is transmitted by a UE) or allowed NSSAIs (where NSSAI IE 400 is transmitted by the network). The NSSAI IE 400 may indicate up to sixteen S-NSSAI values in a configured NSSAI (transmitted by the UE and/or the network).

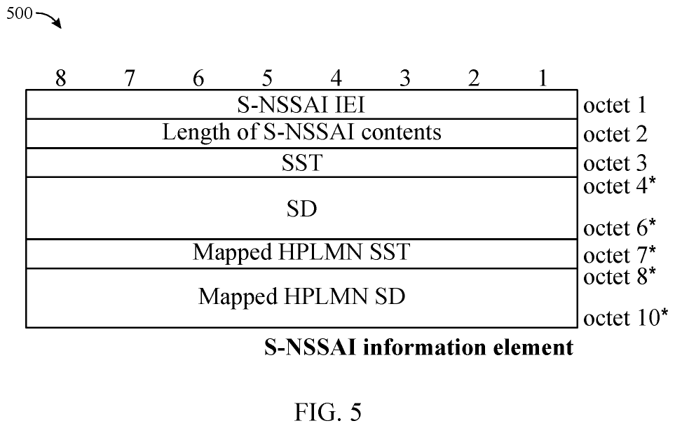

The S-NSSAI identifies a network slice. An example format of an S-NSSAI IE 500 identifying a network slice is shown in FIG. 5. The S-NSSAI IE 500 may have a length between 3 and 10 octets. The S-NSSAI value is coded as the length and value part of the example S-NSSAI IE 500 starting with the second octet. The length of the S-NSSAI IEI field may indicate the length of the included S-NSSAI contents. The SST field may indicate an SST value which, as discussed above, refers to the expected network slice behavior such as features and services supported on the network slide. The SD field may indicate the SD value which, as discussed above, allows for differentiation of different network slices having a same SST value. The mapped HPLMN SST field may indicate the SST value of an S-NSSAI in the S-NSSAI(s) of the HPLMN to which the SST value is mapped. The mapped HPLMN SD field may indicate the SD value of an S-NSSAI in the S-NSSAI(s) of the HPLMN to which the SST value is mapped.

In certain systems, such as 5G NR, the NSSAI IE may be exchanged (e.g., between the UE and the network) as part of mobility management procedures. The NSSAI may be sent at both the non-access stratum (NAS) layer and the access stratum (AS) layer.

In some examples, a Requested NSSAI IE can be sent in a REGISTRATION REQUEST message, except when triggered by a periodic update. As mentioned above, the Requested NSSAI IE may include up to eight S-NSSAI entries, with a size of up to 74 octets.

In some examples, an Allowed NSSAI IE can be sent in a REGISTRATION ACCEPT message, which may be included if the registration procedure is triggered by a periodic update. As mentioned above, the Allowed NSSAI IE may include up to eighth S-NSSAI entries, with a size of up to 74 octets.

In some examples, a Configured NSSAI IE can be sent in a REGISTRATION ACCEPT message. As mentioned above, the Configured NSSAI IE may include up to sixteen S-NSSAI entries, with a size of up to 146 octets.

In some examples, the Allowed NSSAI IE and the Configured NSSAI IE can be sent in a CONFIGURATION UPDATE COMMAND message.

Thus, the UE NAS layer may provide the lower layers with an NSSAI (either requested NSSAI or allowed NSSAI) when the UE sends an initial NAS message while in idle mode.

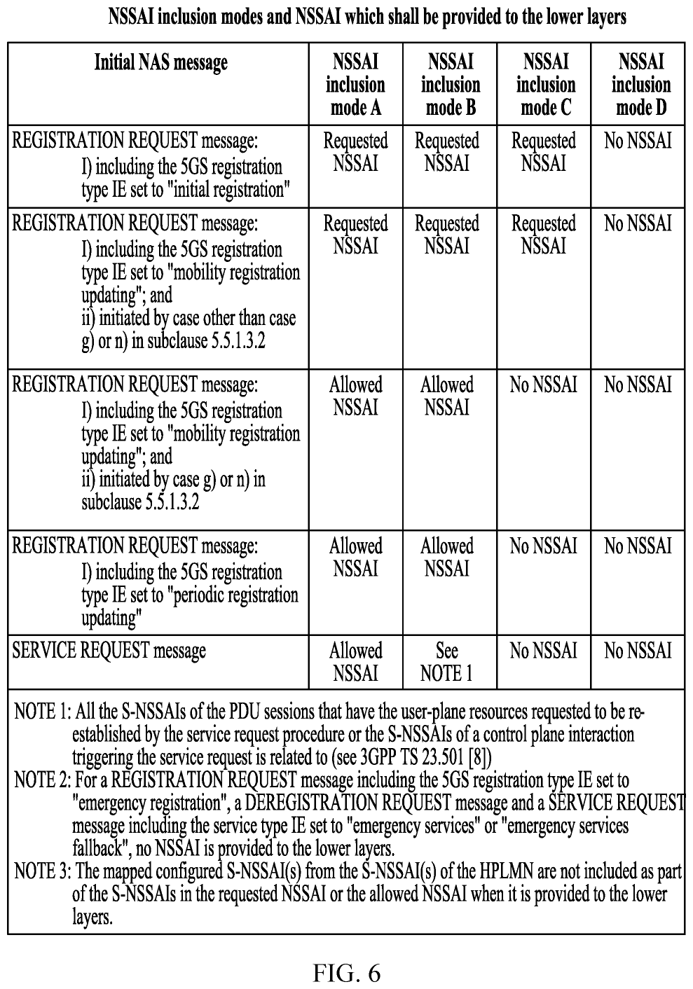

In addition to exchanging NSSAI information at the NAS layer, the UE can be configured to send NSSAI information in the AS layer based on the NSSAI inclusion mode in which it is operating. FIG. 6 is a table showing example NSSAI inclusion modes, based on which different NSSAI information are provided for different NAS procedures. The network (e.g., via the AMF) may indicate which mode the UE operates in via a NSSAI inclusion mode IE that may be sent in the REGISTRATION ACCEPT message.

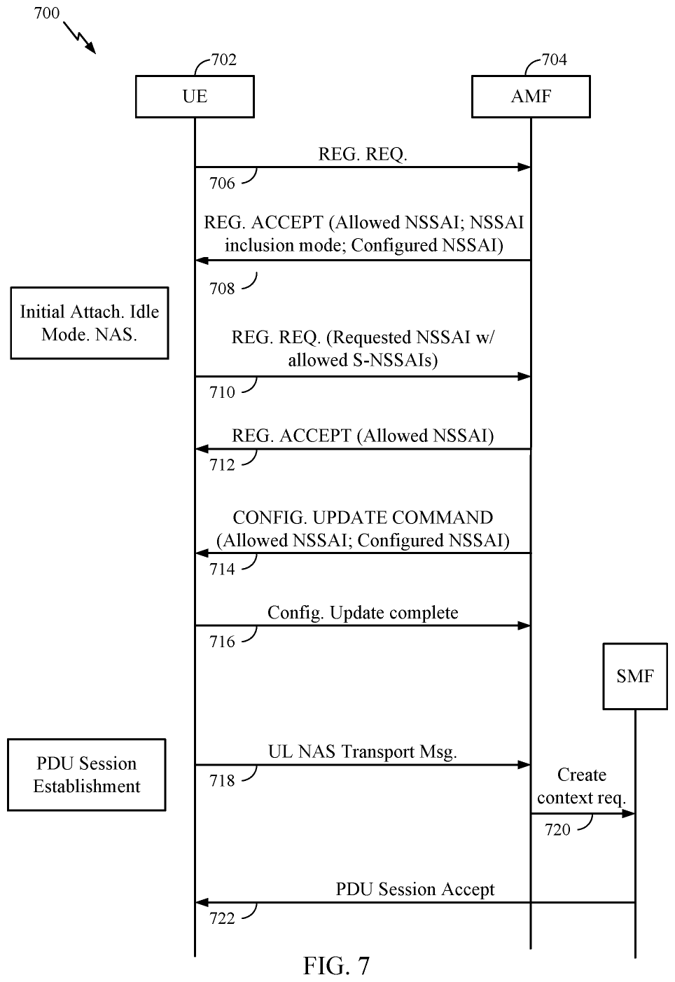

After initial registration, the UE 702 includes the Requested NSSAI IE in the REGISTRATION REQUEST message to the AMF 704, except when the procedure is triggered for a periodic update. Also, the Requested NSSAI IE is included in the NAS message during initial registration even if the UE already has a configured NSSAI or an allowed NSSAI from a previous registration. The Requested NSSAI IE (which can be up to 74 octets long) may be considered duplicated if the UE is operating in NSSAI inclusion mode A or B for which the same information is provided via the AS layer. FIG. 7 is a call flow 700 illustrating example NSSAI signaling. As shown in FIG. 7, NSSAI signaling overhead can be occurred during initial attachment (e.g., such as in registration request messages 710 and registration accept messages 708, 712), during a configuration update (e.g., such as in configuration update commands 714), and/or during PDU session establishment (e.g., such as in UL NAS transport messages 718 and PDU session accept messages 722).

Thus, the NSSAI signaling may be large, involving high overhead. Further, lower layers may be configured to repeat a transmission many times, leading to further overhead, and an increase in UE power consumption. The large overhead, and increased power consumption, may be undesirable for Internet-of-Things (IoT) devices, and especially so for narrowband IoT (NB-IoT) devices.

Accordingly, what is needed are techniques and apparatus for signaling NSSAI with reduced overhead.

### Example Reduced Overhead NSSAI Signaling

Aspects of the present disclosure provide approaches for network slice selection assistance information (NSSAI) signaling. The NSSAI signaling may have reduced overhead (e.g., may use a reduced number of bits to communicate NSSAI information), which may improve the efficiency of NSSAI signaling and allow for resources that may be used for non-reduced-overhead NSSAI signaling to be used for other purposes. NSSAI signaling with reduced overhead, as discussed herein, may be referred to as NSSAI efficient signaling (NES).

According to certain aspects, NES operation may be negotiated (e.g., indicated) between the network and user equipment (UE). For example, a UE and a network entity (e.g., the Access and Mobility Management Function (AMF) in a wireless network) can indicate support for NES. According to certain aspects, for NES operation, a bitmap may be used for NSSAI signaling. Each bit may represent a single NSSAI (S-NSSAI) value. The UE and the network (e.g., the AMF) may then subsequently refer to S-NSSAIs using the bitmap instead of the actual S-NSSAI value. In some examples, this can save 9 octets of overhead. The reduced overhead may be useful for the UEs, such as for narrowband Internet-of-Things (NB-IoT) device UEs or other UEs that may have reduced network capabilities (e.g., a limited number of transmit and receive chains), for which the reduced signaling entailed in NES can reduce power consumption relative to non-reduced-overhead NSSAI signaling.

### Example NES Support Negotiation

According to certain aspects, the UE and/or the network can send an indication that NES operation is supported (and/or requested).

According to certain aspects, the indication that the UE supports NES operation can be provided by the UE in an IE in the REGISTRATION REQUEST message. The UE may not indicate NES support at every registration procedure. For example, the UE may not indicate NES support during a registration procedure that is triggered by a periodic update.

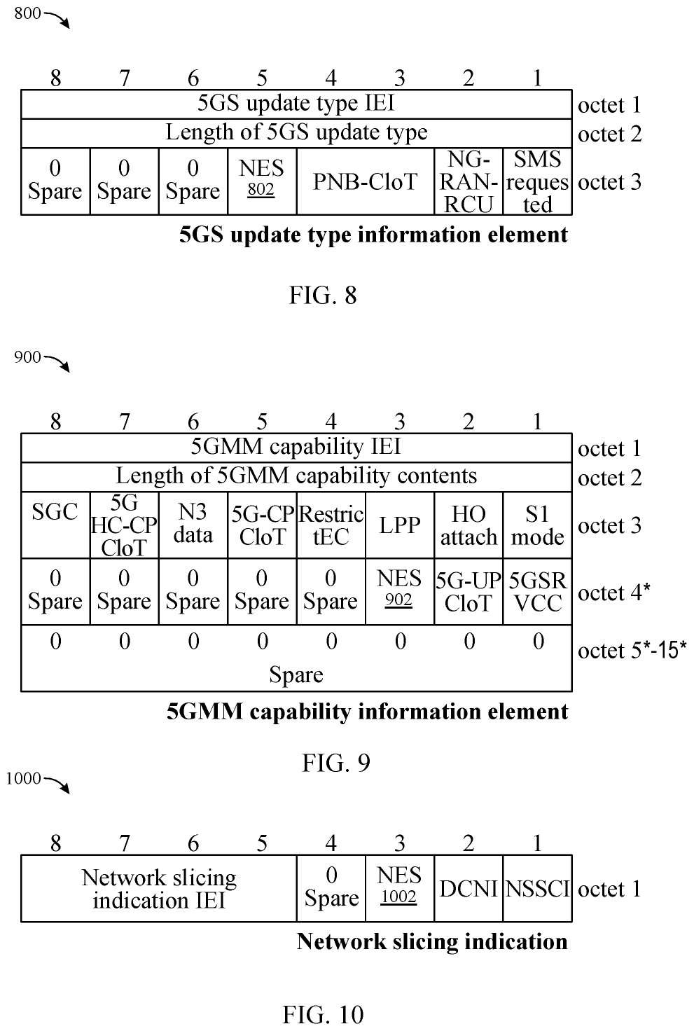

In some examples, a new bit may be defined in the 5GS update type IE 800 to indicate that the UE supports NES, as shown in FIG. 8. The 5GS update type IE 800 may allow the UE to provide additional information to the network when performing a registration procedure. When set to a first value (e.g., ‘1’), the NES bit 802 indicates that NSSAI efficient signaling is supported. Conversely, when set to a second value (e.g., ‘0’), the NES bit 802 indicates that NSSAI efficient signaling is not supported. In the illustrated example, the field in which the NES bit 802 is carried may be introduced as bit 5 of octet 3 in the 5GS update type IE 800, although the bit could be in a different location of the IE.

In some examples, a new bit may be defined in the 5GMM capability IE 900 to indicate that the UE supports NES, as shown in FIG. 9. The 5GMM capability IE 900 may allow the UE to provide the network with information concerning aspects of the UE related to the 5GCN or interworking with the EPS. When set to a first value (e.g., ‘1’), the NES bit 902 indicates that NSSAI efficient signaling is supported. Conversely, when set to a second value (e.g., ‘0’), the NES bit 902 indicates that NSSAI efficient signaling is not supported. In the illustrated example, the field in which the NES bit 902 is carried is introduced as bit 3 of octet 4 in the IE, although the bit could be in a different location of the IE.

In some examples, a new bit may be defined in the network slicing IE 1000 to indicate that the UE supports NES, as shown in FIG. 10. The network slicing IE 1000 may allow the UE to indicate additional information associated with network slicing in the generic UE configuration update procedure and the registration procedure, other than the user's configured NSSAI, allowed NSSAI and rejected NSSAI information. When set to a first value (e.g., ‘1’), the NES bit 1002 indicates that NSSAI efficient signaling is supported. Conversely, when set to a second value (e.g., ‘0’), the NES bit 1002 indicates that NSSAI efficient signaling is not supported. In the illustrated example, the field in which the NES bit 1002 is carried is introduced as bit 3 of octet 4 in the IE, although the bit could be in a different location of the IE.

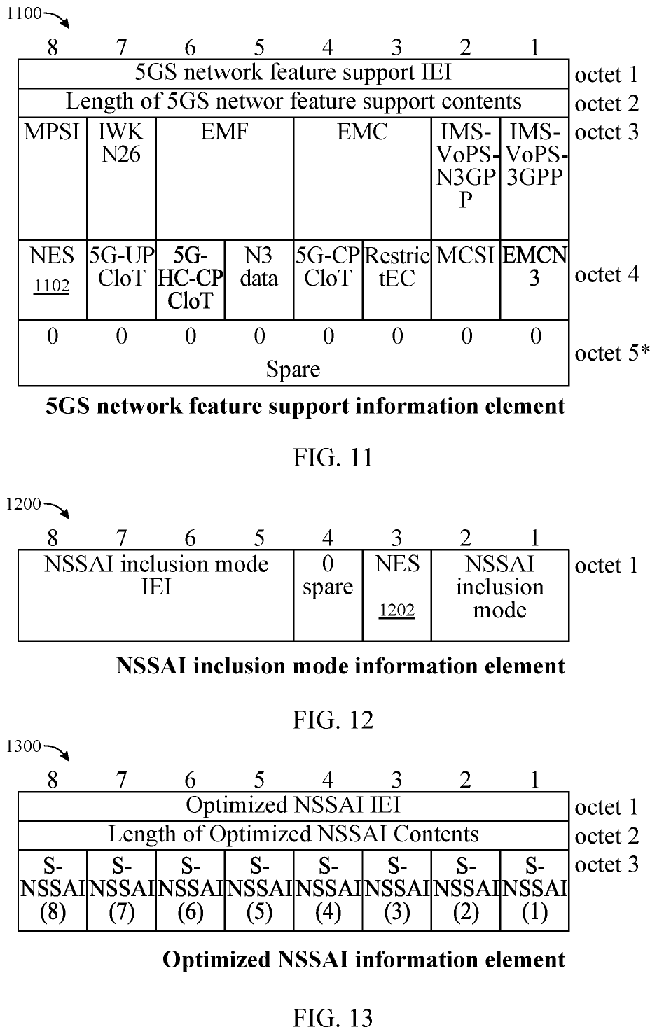

In some examples, the indication can be provided by the network (e.g., the AMF). For example, a new bit may be defined in the 5GS network feature support IE 1100 to indicate that the network supports NES, as shown in FIG. 11. The 5GS network feature support IE 1100 may indicate whether features are supported by the network. When set to a value (e.g., ‘1’), the NES bit 1102 indicates that NSSAI efficient signaling is supported. Conversely, when set to a second value (e.g., ‘0’), the NES bit 1102 indicates that NSSAI efficient signaling is not supported. In the illustrated example, the field in which the NES bit 1102 is carried is introduced as bit 8 of octet 4 in the IE, although the bit could be in a different location of the IE.

In some examples, the indication can be provided by the network (e.g., the AMF) via a new bit may be defined in the NSSAI inclusion mode IE 1200 to indicate that the network supports NES, as shown in FIG. 12. The NSSAI inclusion mode IE 1200 may indicate the NSSAI inclusion mode in which UE is to operate. When set to a first value (e.g., ‘1’), the NES bit 1202 indicates that NSSAI efficient signaling is supported. Conversely, when set to a second value (e.g., ‘0’), the NES bit 1202 indicates that NSSAI efficient signaling is not supported. In the illustrated example, the field in which the NES bit 1202 is carried is introduced as bit 3 of octet 1 in the IE, although the bit could be in a different location of the IE.

In some examples, as discussed in more detail below, presence of Optimized allowed NSSAI IE in the REGISTRATION ACCEPT message can be used as an indication from the network that NES is supported and allowed for the UE.

### Example NES Operation with Bitmap

When NES operation is activated, such as when the UE supports NES operation (e.g., as described above with respect to FIGS. 8-10) and the UE receives the “NSSAI efficient signaling supported” indication from the network (e.g., as described above with respect to FIG. 11 and FIG. 12), the UE and the network operate in the NES mode such that the NSSAI information is signaled efficiently (e.g., with a reduced number of bits).

According to certain aspects, the NES operation may efficiently signal S-NSSAIs using a bitmap. The bitmap may be used in a NSSAI signaling message to refer to a bit locations or fields in a previous message indicating S-NSSAI values. Thus, using the bitmap reduces the number of bits for indicating S-NSSAI values.

In some examples, a new NSSAI signaling IE may be referred to herein as an Optimized NSSAI IE. As shown in FIG. 13, the Optimized NSSAI IE 1300 includes a bitmap (in octet 3 of the Optimized NSSAI IE) in which each bit position corresponds to a specific S-NSSAI entry in the Allowed NSSAI IE (transmitted from the network in REGISTRATION ACCEPT message). Thus, each S-NSSAI value (1-bit field) in the bitmap acts as an index to the S-NSSAI value (or S-NSSAI entry) in the Allowed NSSAI IE. For example, referring to FIG. 13, the S-NSSAI (1) in the NSSAI optimized IE is a reference or index to S-NSSAI value 1 in the Allowed NSSAI IE, S-NSSAI (2) in the NSSAI optimized IE is a reference or index to S-NSSAI value 2 in the Allowed NSSAI IE, and so on. More generally, an n^{th} bit in the bitmap in the Optimized NSSAI IE 1300 corresponds to an n^{th} S-NSSAI value in the Allowed NSSAI IE transmitted from the network in the REGISTRATION ACCEPT message.

The network (e.g., the AMF) can include both a new Optimized Allowed NSSAI IE (e.g., an IE formatted as illustrated by the Optimized NSSAI IE 1300 in FIG. 13) and the Allowed NSSAI IE in a first REGISTRATION ACCEPT message that is sent to the UE. The UE can correlate the S-NSSAIs in the Allowed NSSAI IE and the Optimized Allowed NSSAI IE to determine the bitmap. The UE and the network can store the correlation between S-NSSAI (n) in the Optimized Allowed NSSAI IE and the n^{th} entry or S-NSSAI value n of the Allowed NSSAI IE.

According to certain aspects, presence of the Optimized Allowed NSSAI IE in the REGISTRATION ACCEPT message can be used as an indication from the network that NES is supported and allowed for the UE.

As mentioned above, when the UE is provided with the Optimized Allowed NSSAI IE, the UE associates S-NSSAI (n) with the n^{th} entry of the Allowed NSSAI IE (e.g., with S-NSSAI value n in the Allowed NSSAI IE). Subsequently, the UE can use the mapping in further NSSAI signaling to reduce the overhead. For example, the UE can send a new Optimized Requested NSSAI IE, using the bitmap, in cases when the UE would send the Requested NSSAI IE in the REGISTRATION REQUEST message.

Similarly, the network (e.g., AMF) can use the Optimized Allowed NSSAI IE instead of the Allowed NSSAI IE in cases that the network would send the Allowed NSSAI IE in the REGISTRATION ACCEPT message. The AMF may store the Optimized Allowed NSSAI IE in the UE's context.

According to certain aspects, when one or more of the S-NSSAIs that the UE is allowed to use changes, the bitmap may be updated. For example, the network (e.g., AMF) includes the updated Allowed NSSAI IE indicating the allowed S-NSSAIs, and the updated Optimized Allowed NSSAI IE, in the REGISTRATION ACCEPT message. The network deletes any previous correlation between the bits of a previous Optimized Allowed NSSAI IE and the previous Allowed NSSAI IE that may have been provided to the UE. The network updates and stores the correlation based on the new IEs that are provided to the UE in the REGISTRATION ACCEPT message. The presence of the updated Allowed NSSAI IE and the updated Optimized Allowed NSSAI IE in the REGISTRATION ACCEPT message indicates to the UE to update the bitmap. Thus, the UE, upon receipt of a REGISTRATION ACCEPT message including the updated Allowed NSSAI IE and the updated Optimized Allowed NSSAI IE, deletes any previous association between the bits of the previous Optimized Allowed NSSAI IE and the previous entries in the Allowed NSSAI IE, and the UE performs a new association and subsequent NES signaling as described above but using the updated bitmap.

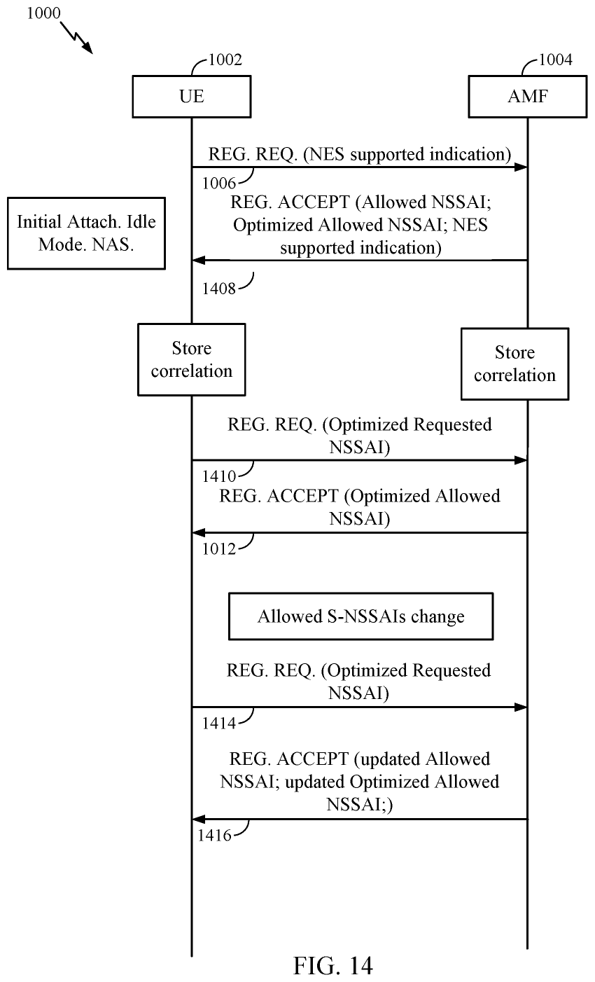

FIG. 14 is a call flow 1400 illustrating example NES negotiation, signaling, and updating as described above. As shown in FIG. 14, at 1406, the UE 1402 can send the REGISTRATION REQUEST message including the indication that the UE 1402 supports (or requests) NES signaling and, at 1408, the AMF 1404 can send the REGISTRATION ACCEPT message indicating the network supports NES. The REGISTRATION ACCEPT message can also include the Allowed NSSAI IE and the Optimized Allowed NSSAI IE in the REGISTRATION ACCEPT message. Both the UE 1402 and the AMF 1404 can store the correlation of the IEs. Subsequently, at 1410, the UE 1402 can send a REGISTRATION REQUEST message including the Optimized Requested NSSAI IE, using the stored correlation. At 1412, the AMF 1404 can send the REGISTRATION ACCEPT message including the Optimized Allowed NSSAI using the stored correlation. As shown in FIG. 14, after the allowed S-NSSAIs for the UE 1402 change, the AMF 1404 can update the correlation by sending the REGISTRATION ACCEPT message, at 1416, including the updated Allowed NSSAI IE and the updated Optimized Allowed NSSAI IE.

Although the above examples describe sending the Optimized allowed NSSAI IE and the Allowed NSSAI IE in the REGISTRATION ACCEPT message, other signaling may also be used. For example, the Optimized allowed NSSAI IE and the Allowed NSSAI IE can also, or alternatively, be sent in the CONFIGURATION UPDATE COMMAND message. In some examples, if the network previously indicated that NES is not supported, the UE should treat the presence of the Optimized allowed NSSAI IE and the Allowed NSSAI IEs in the CONFIGURATION UPDATE COMMAND message as an explicit indication to use NES after which the UE behaves as described above. In some examples, the network can also use any of the IEs discussed above to indicate that the use of NES has changed. For example, the Network slicing indication IE can be sent in the CONFIGURATION UPDATE COMMAND message to indicate an updated NES value.

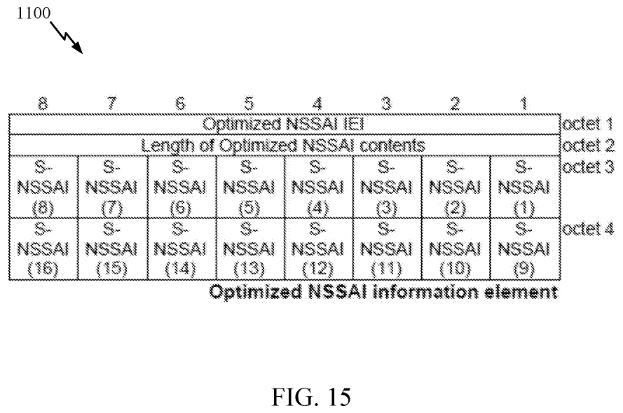

Although the above examples describe sending the Optimized Allowed NSSAI IE and the Allowed NSSAI IE in the REGISTRATION ACCEPT message, other signaling may also be used. For example, the Optimized Configured NSSAI IE 1500 may reference a Configured NSSAI IE, as shown in FIG. 15. In some examples, the UE may request to use new S-NSSAI entries that are part of the Configured NSSAI IE. In this case, the Optimized Configured NSSAI IE 1500 may be defined such that there are 2 octets containing bitmaps corresponding to any of the 16 possible entries in the Configured NSSAI IE, as shown in FIG. 15. Any of the procedures described above for the Optimized Allowed NSSAI (e.g., the correlation, signaling, and updating) may be used with the Optimized Configured NSSAI.

In an example, if the UE has received an allowed NSSAI with 8 S-NSSAI entries, the UE has a configured NSSAI with S-NSSAI entries that are not part of the allowed NSSAI, and if the UE needs to request the use of these other S-NSSAIs, the UE may transmit, to the network, send a request using an Optimized Requested NSSAI IE. However, the UE may only set at most 8 bit positions in the Optimized Requested NSSAI IE to 1 since the UE cannot request more than 8 S-NSSAIs. All bits corresponding to S-NSSAIs that the UE does not request to use should be set to 0. If the AMF receives the IE with more than 8 bits set, the AMF may choose the first 8 bits that are set to determine the S-NSSAIs as described earlier and ignore the rest of the bits that are set to 1.

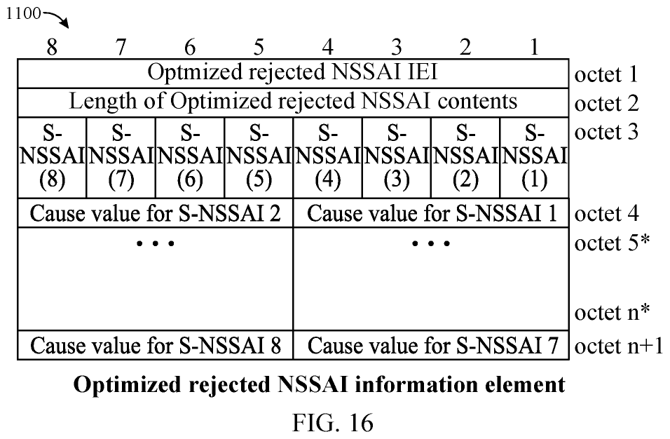

According to certain aspects, an Optimized Rejected NSSAI IE may be used instead of a Rejected NSSAI IE. The Optimized Rejected NSSAI IE 1600 may reference the Allowed NSSAI IE, as shown in FIG. 16. The network may send the Optimized Rejected NSSAI IE 1600 with all its components regardless of how many S-NSSAIs are being rejected. However, the network may only sets the bits (to 1) in octet 3 for the S-NSSAIs that are being rejected. The bit in the bitmap corresponding to an S-NSSAI that is not rejected should be set to 0.

Upon reception of the Optimized Rejected NSSAI IE 1600 at the UE, the UE may consider an S-NSSAI value n (i.e. the n^{th} entry in the Allowed NSSAI) as rejected if the bit S-NSSAI (n) is set to 1. Furthermore, the UE can determine the cause value for the rejected S-NSSAI based on the indication received in the corresponding cause value for the S-NSSAI (from octet 4 to octet n+1), where n can have a maximum value of 6. Alternatively, the AMF may include a cause value in the Optimized Rejected NSSAI IE only for the bits that are set to 1. In such a case, there may be a correlation between each bit that is set to 1 in the Optimized Rejected NSSAI IE and each included cvalue for S-NSSAI field. The first bit that is set to 1 would be associated with the first cause value, the second bit that is set (although may not be adjacent to the previous bit) would be associated with the second included cause value, etc. When an odd number of bits are set in octet 3, the UE ignores the last cause value field that is included since the field cannot be omitted. The field may be set to a specific value to indicate, for example, invalid cause value that the UE may ignore during processing.

### Example NES Operation During PDU Session Establishment

According to certain aspects, the NES operation may be used during PDU session establishment. For example, messages exchanged during the PDU session establishment may reference a previous message indicating S-NSSAIs.

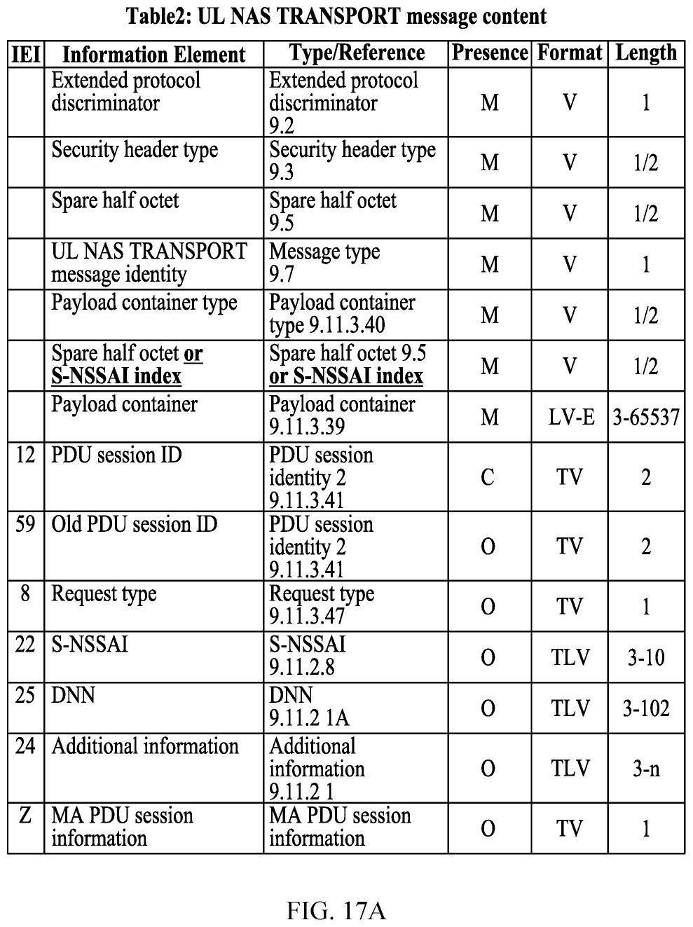

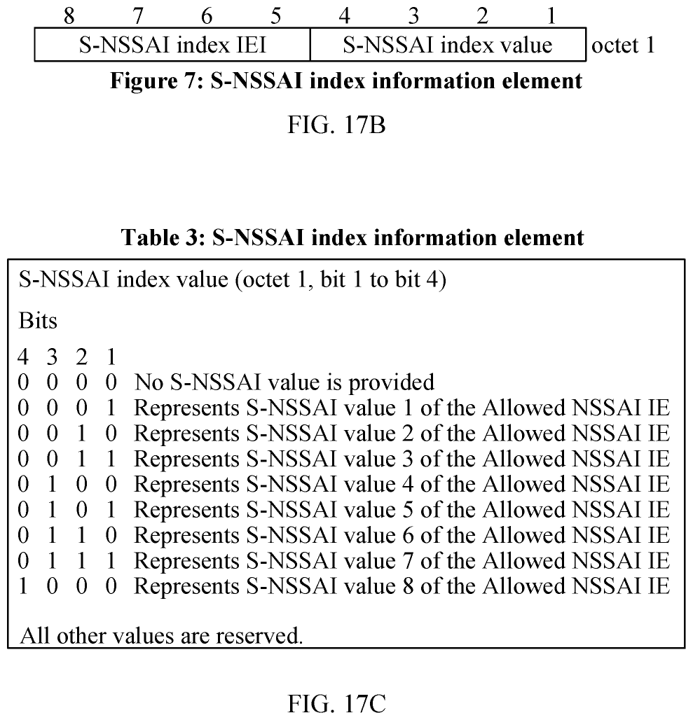

In some examples, the UE can apply NES to the UL NAS TRANSPORT message indicating which S-NSSAI is being requested by using an “S-NSSAI index” field. The payload container IE may include in the UL NAS TRANSPORT message may indicate that a PDU session is being requested. The S-NSSAI IE (which may be an option IE) in the the UL NAS TRANSPORT message may indicate the requested network slice for the PDU session. In some examples, the S-NSSAI index can be included in the existing spare half octet field IE, as shown in FIG. 17A. In some examples, a new field, a new S-NSSAI index IE may be included in the UL NAS TRANSPORT message, as shown in FIG. 17B. When the UE uses the S-NSSAI index field (e.g., in the spare bits) to indicate the S-NSSAI for which the PDU session is being established, the UE does not include the S-NSSAI IE, thereby saving at least 3 octets. The S-NSSAI index may map to the entries of the Allowed NSSAI IE, as shown in FIG. 17C. Thus, the S-NSSAI IE may refer to the S-NSSAI index, rather than directly indicated the S-NSSAI value (which may take up to 10 octets), thereby reducing the overhead.

In some examples, to indicate the S-NSSAI (n) from the Optimized Allowed NSSAI IE (e.g., which corresponds to S-NSSAI value n in the Allowed NSSAI IE), the UE can set the S-NSSAI index field, which is a 4-bits field, to indicate the value n. For example, referring to the example mapping in FIG. 17C, if the UE requests the establishment of a PDU session with the S-NSSAI (5) (i.e. S-NSSAI value 5 in the Allowed NSSAI IE), the UE sets the S-NSSAI index field to “0101”. If the UE does not provide an S-NSSAI value during the PDU session establishment, the UE can set the S-NSSAI index value to “0000” (i.e. to the value zero) indicating that no S-NSSAI has been provided.

When the AMF, that has accepted the use of NES for a UE, receives the UL NAS TRANSPORT message, containing a 5GSM message (e.g., in the payload field) and the request type is set to “initial request”, the AMF verifies the S-NSSAI index field to determine the S-NSSAI that is being requested for the PDU session. If the S-NSSAI index field does not contain a reserved value or the value is not zero, the AMF determines the S-NSSAI as the S-NSSAI value n in the Allowed NSSAI based on the value n that is conveyed in the S-NSSAI index field. The AMF then forwards the 5GSM message and the determined S-NSSAI value to the selected SMF.

In some examples, when the AMF forwards the 5GSM message to the selected SMF, the AMF provides an indication (e.g., “NES indication”) in the message to the SMF (e.g., in a Nsmf_PDUSession_CreateSMContext Request) that is sent to the SMF to indicate that efficient signalling of S-NSSAI is applicable. In the case of a V-SMF, the V-SMF can in turn forward the indication to the H-SMF.

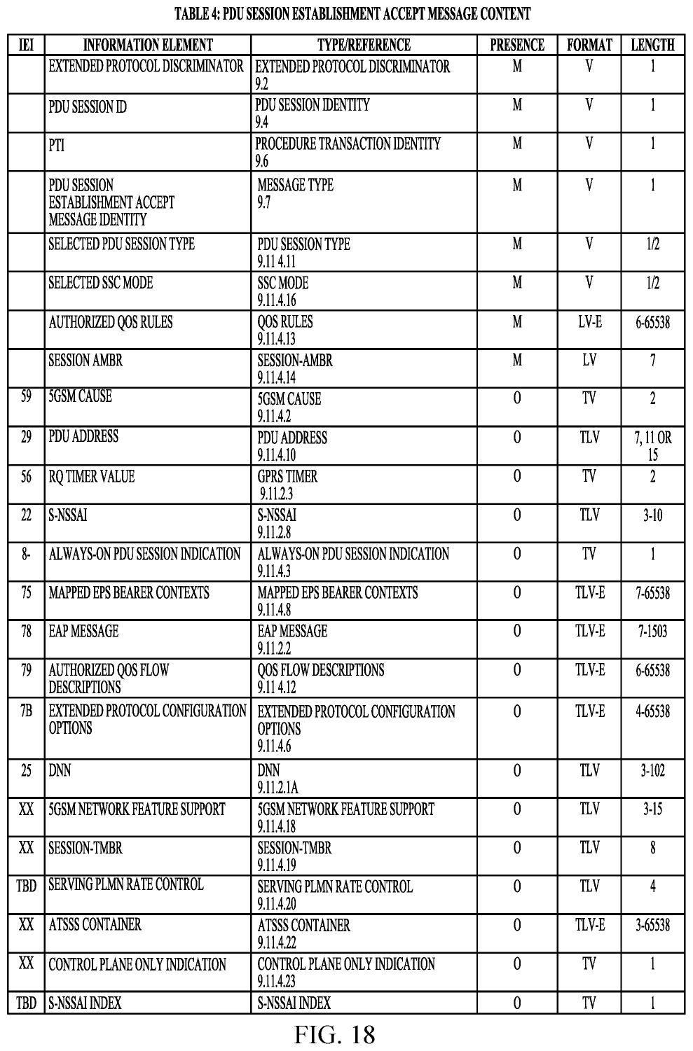

Upon reception of an NES indication from the AMF, the SMF also applies NES on the 5GSM response message by including the S-NSSAI index IE in the PDU SESSION ESTABLISHMENT ACCEPT message, as shown in FIG. 18. When doing so, the SMF does not include the S-NSSAI IE in the PDU SESSION ESTABLISHMENT ACCEPT message, as shown in FIG. 18, which would then save at least 3 octets. Thus, other fields in the PDU SESSION ESTABLISHMENT ACCEPT message can refer to the S-NSSAI index.

Upon reception of the PDU SESSION ESTBALISHMENT ACCEPT message at the UE, if the S-NSSAI index IE is included, the UE determines the associated S-NSSAI value. In some examples, the UE determines the S-NSSAI by interacting with the 5GMM entity.

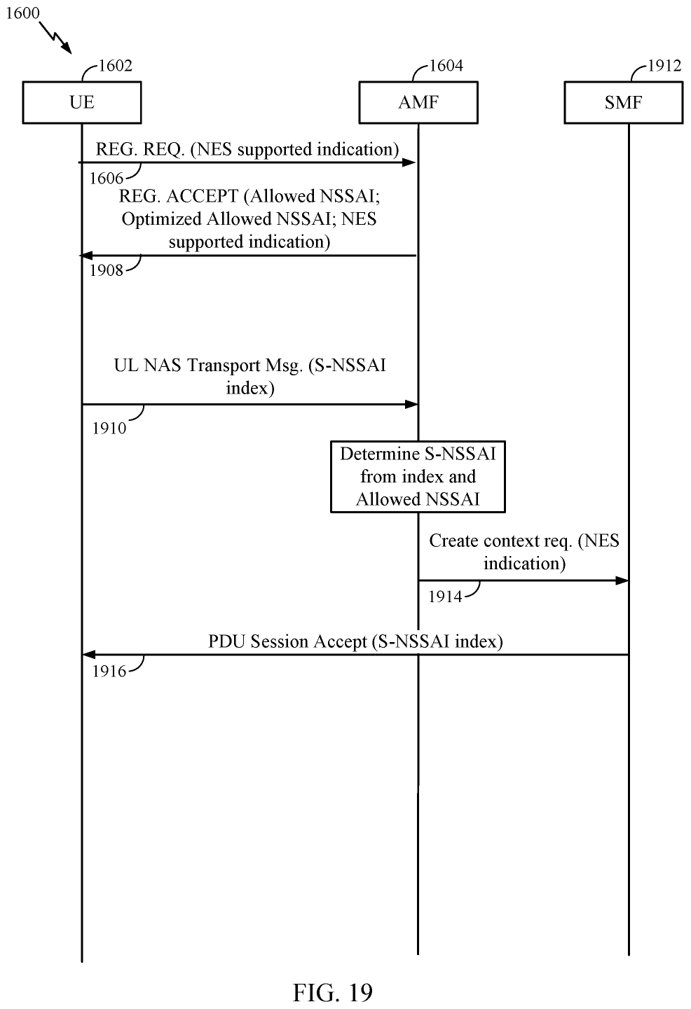

FIG. 19 is a call flow 1900 diagram illustrating example signaling for NES operation during PDU session establishment, in accordance with aspects of the present disclosure. As shown in FIG. 19, the UE 1902 and the AMF 1904 can negotiate the NES operation and configure (e.g., determine, correlate) the allowed S-NSSAI values, at steps 1906 and 1908. Although FIG. 19 shows the registration messages, as discussed above, the NES can be configured during Configuration Update. Although FIG. 19 shows using the Allowed S-NSSAI IE, as discussed above, the NES can be configured using the Configured S-NSSAI IE. As shown in FIG. 19, at 1910, the UE 1902 sends the AMF 1904 an UL NAS TRANSPORT message including the S-NSSAI index. The AMF 1904 can determine the requested S-NSSAI value from the S-NSSAI index (and the referenced previous Allowed NSSAI IE). The AMF 1904 forwards the information (e.g., a create context request message) including an NES indication to the SMF 1912. The SMF 1912 can then send the PDU SESSION ESTABLISHMENT ACCEPT message including the S-NSSAI index. Thus, the PDU session establishment may have reduced overhead.

### Example NES Operation During AMF Relocation

A UE can move to another served by a new AMF. In this case, the new AMF (e.g., target AMF) may try to fetch the UE context from the previous AMF (e.g., the source AMF). According to certain aspects, the source AMF should provide the target AMF with the context information including the mapping of bits to the Allowed NSSAI IE). For example, the source AMF can provide the Optimized allowed NSSAI IE if the source AMF has allowed the use of NES for the UE. In some examples, the source AMF may provide the mapping to the target AMF in a new IE (e.g., in a Namf_Communication_UEContextTransfer service message). Thus, the target AMF may use the mapping for NES operation with the UE. In this case, the target AMF may include the Optimized allowed NSSAI IE in the REGISTRATION ACCEPT message without including the Allowed NSSAI IE.

### Example NES Operation Triggers

According to certain aspects, the UE and the network can switch between the NES operation and normal operation.

According to certain aspects, the NES mode may be used when the UE requests the use of NES and the network indicates support and allows the use of NES (e.g., as described above). In some examples, the UE may request the use of NES based on a local configuration of the UE; when the UE performs an inter-system mobility, such as the NB-N1 mode (i.e. the UE moves into NB-IoT cell); and/or when the UE enters a new tracking area that is not part of the UE's registration area.

According to certain aspects, the NES mode may be used based on the UE receiving a REGISTRATION ACCEPT message or a CONFIGURATION UPDATE COMMAND message. In some examples, the UE uses the NES mode when the UE receives a REGISTRATION ACCEPT message or a CONFIGURATION UPDATE COMMAND message including the NES bit set to 1 (e.g., in the 5GS network feature support IE or in the NSSAI inclusion mode IE); and/or including the Optimized allowed NSSAI IE and the Allowed NSSAI IE.

According to certain aspects, the UE may stop using the NES mode when the UE receives a REGISTRATION ACCEPT message or a CONFIGURATION UPDATE COMMAND message with the NES bit set to 0 (e.g., in the 5GS network feature support IE or the NSSAI inclusion mode IE); when the UE receives a REGISTRATION ACCEPT message or a CONFIGURATION UPDATE COMMAND message that includes an Allowed NSSAI IE but does not include the Optimized allowed NSSAI IE; when the UE moves from NB-N1 mode to WB-N1 mode; and/or when the UE enters to cell whose tracking area identity is not in the UE's current registration area (e.g., when the UE moves out of the current registration area).

In some examples, the UE may stop using NES when the UE receives a rejected NSSAI but without receiving the allowed NSSAI and optimized allowed NSSAI.

In some examples, the UE may stop using NES when it deregisters with the network.

In some examples, the UE may stop using NES when it moves from N1 mode to S1 mode.

### Example Aspects

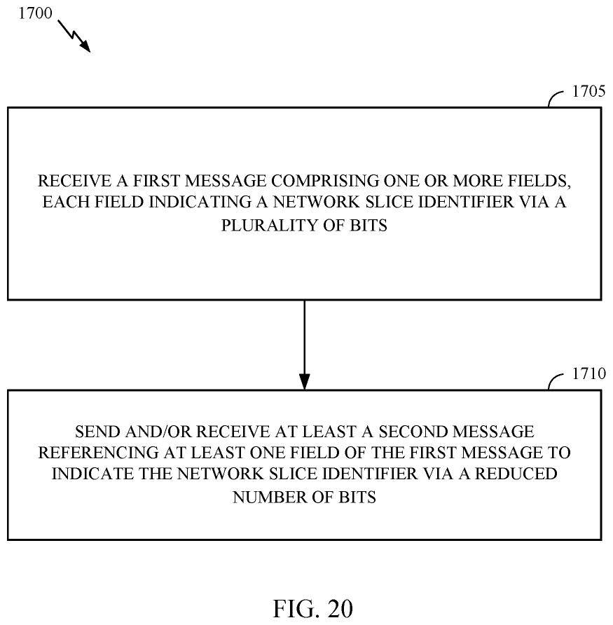

FIG. 20 is a flow diagram illustrating example operations 2000 for wireless communication, in accordance with certain aspects of the present disclosure. The operations 2000 may be performed, for example, by UE (e.g., such as a UE 120a in the wireless communication network 100). Operations 2000 may be implemented as software components that are executed and run on one or more processors (e.g., controller/processor 280 of FIG. 2). Further, the transmission and reception of signals by the UE in operations 2000 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 2000 may begin, at 2005, by receiving a first message comprising one or more fields, each field indicating a network slice identifier via a plurality of bits.

At 2010, the UE sends and/or receives at least a second message referencing at least one field of the first message to indicate the network slice identifier via a reduced number of bits.

In a first aspect, the second message may reference the first message via a bitmap, each bit associated with one of the fields in the first message.

In a second aspect, alone or in combination with the first aspect, the one or more network slice identifiers include S-NSSAI and the first message is an allowed NSSAI IE or a configured NSSAI IE in a registration accept message or configuration update command message.

In a third aspect, alone or in combination with first and/or second aspect, the UE sends the second message as a requested NSSAI IE in a registration request message; and/or receives the second message as an allowed NSSAI IE or a rejected NSSAI IE in a registration accept message.

In a fourth aspect, alone or in combination with one or more of the first through third aspects, the rejected NSSAI IE includes cause values for each network slice identifier referenced or for network slice identifiers that are rejected.

In a fifth aspect, alone or in combination with one or more of the first through fourth aspects, the UE receives a third message indicating the bitmap.

In a sixth aspect, alone or in combination with one or more of the first through fifth aspects, presence of the third message indicates that the network supports or requests network slice identifier signaling with reduced bits.

In a seventh aspect, alone or in combination with one or more of the first through sixth aspects, the UE receives an updated bitmap when the allowed network slices change; and sends and/or receives subsequent message using the updated bitmap.

In an eighth aspect, alone or in combination with one or more of the first through seventh aspects, the second message is an uplink NAS transport message.

In a ninth aspect, alone or in combination with one or more of the first through eighth aspects, a field in the UL NAS transport message indicates an index referencing the fields in the first message; and at least one other field in the UL NAS transport message includes a value from the index to indicate a network slice identifier.

In a tenth aspect, alone or in combination with one or more of the first through ninth aspects, the index is provided in a half octet field or in a new field in the UL NAS transport message.

In an eleventh aspect, alone or in combination with one or more of the first through tenth aspects, the UE receives a PDU session establishment accept message; a field in the PDU session establishment accept message indicates the index referencing the fields in the first message; and at least one other field in the PDU session establishment accept message includes a value from the index to a indicate network slice identifier.

In a twelfth aspect, alone or in combination with one or more of the first through eleventh aspects, the UE provides an indication that the UE supports or requests network slice identifier signaling with reduced bits.

In a thirteenth aspect, alone or in combination with one or more of the first through twelfth aspects, the indication that the UE supports or requests network slice identifier signaling with reduced bits is provided in a registration request message.

In a fourteenth aspect, alone or in combination with one or more of the first through thirteenth aspects, the indication that the UE supports or requests network slice identifier signaling with reduced bits is provided in a field of a 5GS update type IE, a 5GMM capability IE, or a network slicing indication IE in the registration request message.

In a fifteenth aspect, alone or in combination with one or more of the first through fourteenth aspects, the UE receives an indication that the network supports or requests network slice identifier signaling with reduced bits.

In a sixteenth aspect, alone or in combination with one or more of the first through fifteenth aspects, the indication that the network supports or requests network slice identifier signaling with reduced bits is provided in a registration accept message.

In a seventeenth aspect, alone or in combination with one or more of the first through sixteenth aspects, the indication that the network supports or requests network slice identifier signaling with reduced bits is provided in a field of a 5GS network feature support IE or NSSAI inclusion mode IE in the registration accept message.

In an eighteenth aspect, alone or in combination with one or more of the first through seventeenth aspects, the indication that the UE support or requests network slice identifier signaling with reduced bits is provided based at least one of: a configuration of the UE; when the UE enters a narrowband IoT cell; or when the UE enters a new tracking area that is not part of the UE's registration area.

In a nineteenth aspect, alone or in combination with one or more of the first through eighteenth aspects, the UE sends messages using regular network slice identifier signaling without reduced bits when the UE receives an indication from the network that network slice identifier signaling with reduced bits is not supported; when the UE receives a message from the network using regular network slice identifier signaling without reduced bits; when the UE leaves a narrowband IoT cell; and/or when the UE enters a tracking area not part of the UE's registration area.

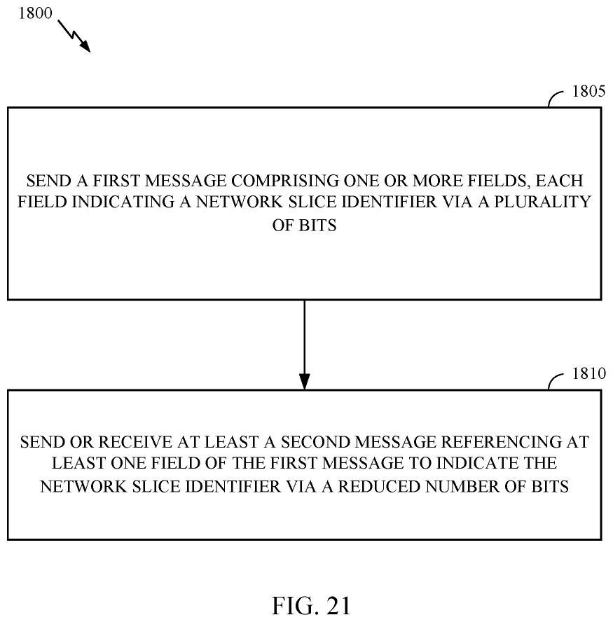

FIG. 21 is a flow diagram illustrating example operations 2100 for wireless communication, in accordance with certain aspects of the present disclosure. The operations 2100 may be performed, for example, by a network (e.g., such as an AMF in the CN 130). Operations 2100 may be complementary to the operations 2000 by the UE.

The operations 2100 may begin, at 2105, by sending a first message comprising one or more fields, each field indicating a network slice identifier via a plurality of bits.

At 2110, the network entity sends and/or receives at least a second message referencing at least one field of the first message to indicate the network slice identifier via a reduced number of bits.

In a first aspect, the second message may reference the first message via a bitmap, each bit associated with one of the fields in the first message.

In a second aspect, alone or in combination with the first aspect, the one or more network slice identifiers include S-NSSAI and the first message is an allowed NSSAI IE or a configured NSSAI IE in a registration accept message or configuration update command message.

In a third aspect, alone or in combination with first and/or second aspect, the network entity receives the second message as a requested NSSAI IE in a registration request message; and/or receives the second message as an allowed NSSAI IE or a rejected NSSAI IE in a registration accept message.

In a fourth aspect, alone or in combination with one or more of the first through third aspects, the rejected NSSAI IE includes cause values for each network slice identifier referenced or for network slice identifiers that are rejected.

In a fifth aspect, alone or in combination with one or more of the first through fourth aspects, the UE receives a third message indicating the bitmap.

In a sixth aspect, alone or in combination with one or more of the first through fifth aspects, presence of the third message indicates that the network supports or requests network slice identifier signaling with reduced bits.

In a seventh aspect, alone or in combination with one or more of the first through sixth aspects, the network entity sends an updated bitmap when the allowed network slices change; and sends and/or receives subsequent message using the updated bitmap.

In an eighth aspect, alone or in combination with one or more of the first through seventh aspects, the second message is an uplink NAS transport message.

In a ninth aspect, alone or in combination with one or more of the first through eighth aspects, a field in the UL NAS transport message indicates an index referencing the fields in the first message; and at least one other field in the UL NAS transport message includes a value from the index to indicate a network slice identifier.

In a tenth aspect, alone or in combination with one or more of the first through ninth aspects, the index is received in a half octet field or in a new field in the UL NAS transport message.

In an eleventh aspect, alone or in combination with one or more of the first through tenth aspects, the network entity sends a PDU session establishment accept message; a field in the PDU session establishment accept message indicates the index referencing the fields in the first message; and at least one other field in the PDU session establishment accept message includes a value from the index to a indicate network slice identifier.

In a twelfth aspect, alone or in combination with one or more of the first through eleventh aspects, the network entity receives an indication that the UE supports or requests network slice identifier signaling with reduced bits.

In a thirteenth aspect, alone or in combination with one or more of the first through twelfth aspects, the indication that the UE supports or requests network slice identifier signaling with reduced bits is received in a registration request message.

In a fourteenth aspect, alone or in combination with one or more of the first through thirteenth aspects, the indication that the UE supports or requests network slice identifier signaling with reduced bits is received in a field of a 5GS update type IE, a 5GMM capability IE, or a network slicing indication IE in the registration request message.

In a fifteenth aspect, alone or in combination with one or more of the first through fourteenth aspects, the network entity sends an indication that the network supports or requests network slice identifier signaling with reduced bits.

In a sixteenth aspect, alone or in combination with one or more of the first through fifteenth aspects, the indication that the network supports or requests network slice identifier signaling with reduced bits is provided in a registration accept message.

In a seventeenth aspect, alone or in combination with one or more of the first through sixteenth aspects, the indication that the network supports or requests network slice identifier signaling with reduced bits is provided in a field of a 5GS network feature support IE or NSSAI inclusion mode IE in the registration accept message.

In an eighteenth aspect, alone or in combination with one or more of the first through seventeenth aspects, the indication that the UE support or requests network slice identifier signaling with reduced bits is received based on at least one of: a configuration of the UE; when the UE enters a narrowband IoT cell; or when the UE enters a new tracking area that is not part of the UE's registration area.

In a nineteenth aspect, alone or in combination with one or more of the first through eighteenth aspects, the network entity receives messages using regular network slice identifier signaling without reduced bits when the UE receives an indication from the network that network slice identifier signaling with reduced bits is not supported; when the UE receives a message from the network using regular network slice identifier signaling without reduced bits; when the UE leaves a narrowband IoT cell; and/or when the UE enters a tracking area not part of the UE's registration area.

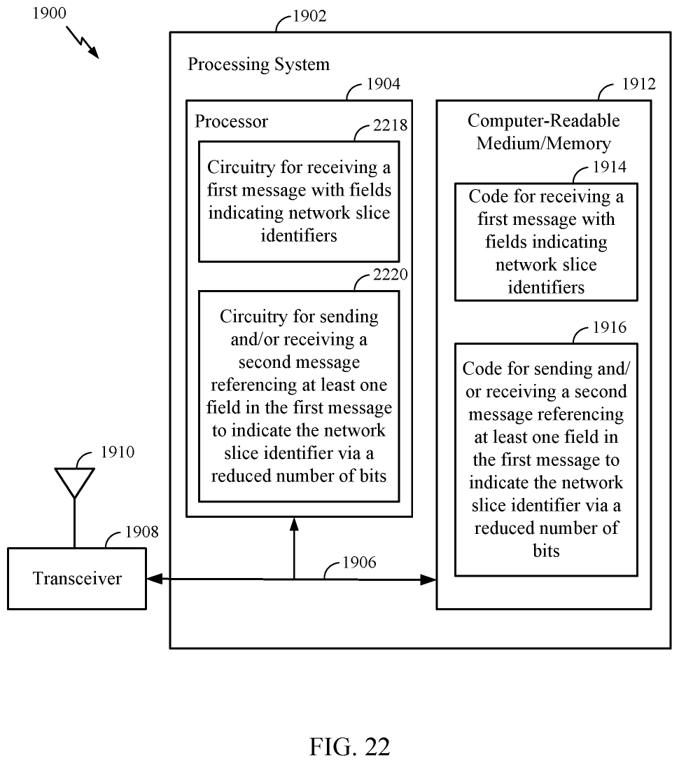

FIG. 22 illustrates a communications device 2200 that may include various components (e.g., corresponding to means-plus-function components) configured to perform operations for the techniques disclosed herein, such as the operations illustrated in FIG. 20. The communications device 2200 includes a processing system 2202 coupled to a transceiver 2208 (e.g., a transmitter and/or a receiver). The transceiver 2208 is configured to transmit and receive signals for the communications device 2200 via an antenna 2210, such as the various signals as described herein. The processing system 2202 may be configured to perform processing functions for the communications device 2200, including processing signals received and/or to be transmitted by the communications device 2200.

The processing system 2202 includes a processor 2204 coupled to a computer-readable medium/memory 2212 via a bus 2206. In certain aspects, the computer-readable medium/memory 2212 is configured to store instructions (e.g., computer-executable code) that when executed by the processor 2204, cause the processor 2204 to perform the operations illustrated in FIG. 20, or other operations for performing the various techniques discussed herein for reduced overhead NSSAI signaling. In certain aspects, computer-readable medium/memory 2212 stores code 2214 for receiving a first message comprising one or more fields, each field indicating a network slice identifier via a plurality of bits and code 2216 for sending and/or receiving at least a second message referencing at least one field of the first message to indicate the network slice identifier via a reduced number of bits, in accordance with aspects of the disclosure. In certain aspects, the processor 2204 has circuitry configured to implement the code stored in the computer-readable medium/memory 2212. The processor 2204 includes circuitry 2218 for receiving a first message comprising one or more fields, each field indicating a network slice identifier via a plurality of bits and circuitry 2220 for sending and/or receiving at least a second message referencing at least one field of the first message to indicate the network slice identifier via a reduced number of bits, in accordance with aspects of the disclosure.

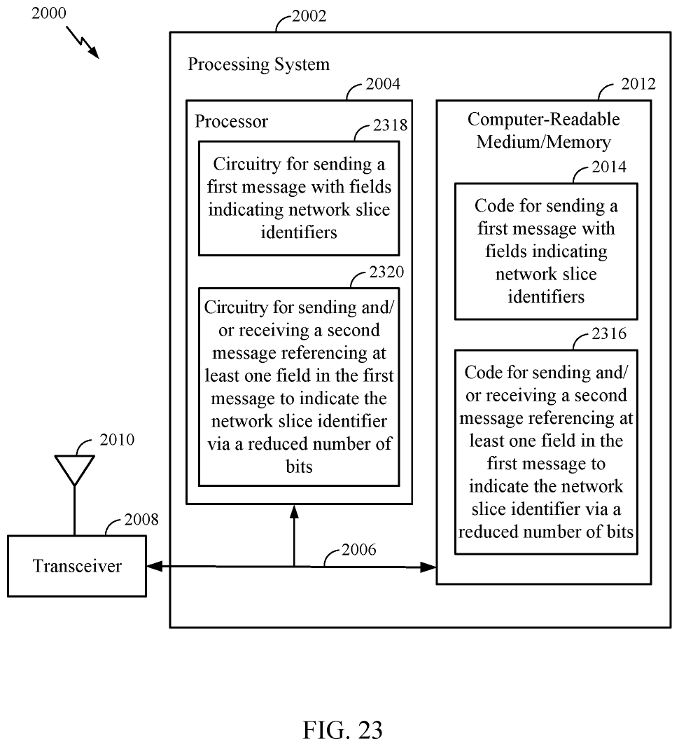

FIG. 23 illustrates a communications device 2300 that may include various components (e.g., corresponding to means-plus-function components) configured to perform operations for the techniques disclosed herein, such as the operations illustrated in FIG. 21. The communications device 2300 includes a processing system 2302 coupled to a transceiver 2308 (e.g., a transmitter and/or a receiver). The transceiver 2308 is configured to transmit and receive signals for the communications device 2300 via an antenna 2310, such as the various signals as described herein. The processing system 2302 may be configured to perform processing functions for the communications device 2300, including processing signals received and/or to be transmitted by the communications device 2300.

The processing system 2302 includes a processor 2304 coupled to a computer-readable medium/memory 2312 via a bus 2306. In certain aspects, the computer-readable medium/memory 2312 is configured to store instructions (e.g., computer-executable code) that when executed by the processor 2304, cause the processor 2304 to perform the operations illustrated in FIG. 21, or other operations for performing the various techniques discussed herein for reduced overhead NSSAI signaling. In certain aspects, computer-readable medium/memory 2312 stores code 2314 for sending a first message comprising one or more fields, each field indicating a network slice identifier via a plurality of bits and code 2316 for sending and/or receiving at least a second message referencing at least one field of the first message to indicate the network slice identifier via a reduced number of bits, in accordance with aspects of the disclosure. In certain aspects, the processor 2204 has circuitry configured to implement the code stored in the computer-readable medium/memory 2212. The processor 2204 includes circuitry 2318 sending a first message comprising one or more fields, each field indicating a network slice identifier via a plurality of bits and circuitry 2320 for sending and/or receiving at least a second message referencing at least one field of the first message to indicate the network slice identifier via a reduced number of bits, in accordance with aspects of the disclosure.

### ADDITIONAL CONSIDERATIONS

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In some examples, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 20 and/or FIG. 21.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a user equipment (UE), comprising:
receiving a first message comprising one or more fields, each field of the one or more fields indicating a network slice identifier via a plurality of bits; and
at least one of sending or receiving at least a second message referencing at least one field of the first message to indicate the network slice identifier via a reduced number of bits.

2. The method of claim 1, wherein:
the one or more network slice identifiers comprises single network slice selection assistance information (S-NSSAI); and
the first message comprises an allowed NSSAI information element (IE) or a configured NSSAI IE in a registration accept message or configuration update command message.

3. The method of claim 2, wherein:
sending the second message comprises sending the second message as a requested NSSAI IE in a registration request message; and
receiving the second message comprises receiving the second message as an allowed NSSAI IE or a rejected NSSAI IE in a registration accept message.

4. The method of claim 1, wherein:
the second message references the first message via a bitmap, and
each bit in the bitmap is associated with one of the one or more fields in the first message.

5. The method of claim 4, further comprising receiving a third message indicating the bitmap.

6. The method of claim 5, wherein presence of the third message indicates that the network supports or requests network slice identifier signaling with reduced bits.

7. The method of claim 4, further comprising:
receiving an updated bitmap when allowed network slices change; and
at least one of: sending or receiving subsequent message using the updated bitmap.

8. The method of claim 1, wherein sending the second message comprises sending an uplink (UL) non-access stratum (NAS) transport message.

9. The method claim 8, wherein:
a field in the UL NAS transport message indicates an index referencing the fields in the first message; and
at least one other field in the UL NAS transport message comprises a value from the index to indicate a network slice identifier.

10. The method of claim 8, wherein:
the method further comprises receiving a protocol data unit (PDU) session establishment accept message;
a field in the PDU session establishment accept message indicates an index referencing the fields in the first message; and
at least one other field in the PDU session establishment accept message comprises a value from the index to a indicate network slice identifier.

11. The method of claim 1, further comprising providing an indication that the UE supports or requests network slice identifier signaling with reduced bits.

12. The method of claim 11, wherein the indication that the UE support or requests network slice identifier signaling with reduced bits is provided based on at least one of:
a configuration of the UE,
when the UE enters a narrowband Internet-of-Things (IoT) cell, or
when the UE enters a new tracking area that is not part of a registration area associated with the UE.

13. The method of claim 1, further comprising receiving an indication that the network supports or requests network slice identifier signaling with reduced bits.

14. The method of claim 1, further comprising:
sending messages using regular network slice identifier signaling without reduced bits when at least one of:
the UE receives an indication from the network that network slice identifier signaling with reduced bits is not supported;
the UE receives a message from the network using regular network slice identifier signaling without reduced bits; the UE leaves a narrowband Internet-of-Things (IoT) cell, or
the UE enters a tracking area not part of a registration area associated with the UE.

15. A method for wireless communications by a network entity, comprising:
sending, to a user equipment (UE) a first message comprising one or more fields, each field of the one or more fields indicating a network slice identifier via a plurality of bits; and
at least one of: sending to the UE or receiving from the UE at least a second message referencing at least one field of the first message to indicate the network slice identifier via a reduced number of bits.

16. The method of claim 15, wherein:
the one or more network slice identifiers comprises single network slice selection assistance information (S-NSSAI); and
the first message comprises an allowed NSSAI information element (IE) or a configured NSSAI IE in a registration accept message or configuration update command message.

17. The method of claim 16, wherein:
receiving the second message comprises receiving the second message as a requested NSSAI IE in a registration request message; and
sending the second message comprises sending the second message as an allowed NSSAI IE or a rejected NSSAI IE in a registration accept message.

18. The method of claim 15, wherein the second message references the first message via a bitmap, and each bit in the bitmap is associated with one of the fields in the first message.

19. The method of claim 18, further comprising sending a third message indicating the bitmap.

20. The method of claim 19, wherein presence of the third message indicates that the network supports or requests network slice identifier signaling with reduced bits.

21. The method of claim 19, further comprising:
sending an updated bitmap when allowed network slices change; and
at least one of: sending or receiving subsequent message using the updated bitmap.

22. The method of claim 15, wherein receiving the second message comprises receiving an uplink (UL) non-access stratum (NAS) transport message.

23. The method claim 22, wherein:
a field in the UL NAS transport message indicates an index referencing the fields in the first message; and
at least one other field in the UL NAS transport message comprises a value from the index to indicate a network slice identifier.

24. The method of claim 22, wherein:
the method further comprises sending a protocol data unit (PDU) session establishment accept message;
a field in the PDU session establishment accept message indicates an index referencing the fields in the first message; and
at least one other field in the PDU session establishment accept message comprises a value from the index to a indicate network slice identifier.

25. The method of claim 15, further comprising receiving an indication that the UE supports or requests network slice identifier signaling with reduced bits.

26. The method of claim 21, further comprising sending an indication that the network supports or requests network slice identifier signaling with reduced bits.

27. The method of claim 26, wherein the indication that the UE support or requests network slice identifier signaling with reduced bits is received based on at least one of:
a configuration of the UE,
when the UE enters a narrowband Internet-of-Things (IoT) cell, or
when the UE enters a new tracking area that is not part of a registration area associated with the UE.

28. The method of claim 15, further comprising: receiving messages using regular network slice identifier signaling without reduced bits when at least one of:
the UE receives an indication from the network that network slice identifier signaling with reduced bits is not supported,
the UE receives a message from the network using regular network slice identifier signaling without reduced bits,
the UE leaves a narrowband Internet-of-Things (IoT) cell, or
the UE enters a tracking area not part of a registration area associated with the UE.

29. An apparatus for wireless communications by a user equipment (UE), comprising:
a memory; and
at least one processor coupled with the memory and configured to:
receive a first message comprising one or more fields, each field indicating a network slice identifier via a plurality of bits; and
at least one of: send or receive at least a second message referencing at least one field of the first message to indicate the network slice identifier via a reduced number of bits.

30. An apparatus for wireless communications by a network entity, comprising:
a memory; and
at least one processor coupled with the memory and configured to:
send, to a user equipment (UE), a first message comprising one or more fields, each field indicating a network slice identifier via a plurality of bits; and
at least one of: send to the UE or receive from the UE at least a second message referencing at least one field of the first message to indicate the network slice identifier via a reduced number of bits.
